(19) United States
(12) Patent Application Publication
(10) Pub. No.: US 2020/0182634 A1
(43) Pub. Date: Jun. 11, 2020

(54) PROVIDING PATH DIRECTIONS RELATING TO A SHOPPING CART

(71) Applicant: UXR LLC, Tallahassee, FL (US)

(72) Inventor: Peter Karceski, Tallahassee, FL (US)

(21) Appl. No.: 16/210,763

(22) Filed: Dec. 5, 2018

(51) Int. Cl. G01C 21/34; G01C 21/30; B62B 3/14; G01S 17/89

(52) U.S. Cl. CPC G01C 21/3407; G01S 17/89; B62B 3/1472; G01C 21/30

(57) ABSTRACT

A system includes: a shopping cart having wheels; a navigation component mounted to the shopping cart, the navigation component having at least one processor and a memory, the navigation component having access to a map of a store; mounted to the shopping cart and configured to provide input to the navigation component, at least one of a sonar or an odometry unit, the navigation component generating a navigation signal using the input and the map; and a display device mounted to the shopping cart and coupled to the navigation component, the display device outputting path directions for the store based on the navigation signal.

### TECHNICAL FIELD

This document relates, generally, to providing path directions relating to a shopping cart.

### BACKGROUND

Retailers and other vendors offering goods for purchase to customers sometimes provide shopping carts to carry the customer's selected goods during at least the shopping session. A customer may be shopping for their own benefit using the shopping cart or they may be shopping on behalf of someone else who has instructed the customer which goods to purchase. Some grocery stores have attempted to simplify the task for the latter type of customer by providing the customer with a map of the store (e.g., a grocery store) and information about the locations of items in the store. Shopping carts may also be used by others than customers, such as by store employees.

### SUMMARY

In a first aspect, a system includes: a shopping cart having wheels; a navigation component mounted to the shopping cart, the navigation component having at least one processor and a memory, the navigation component having access to a map of a store; mounted to the shopping cart and configured to provide input to the navigation component, at least one of a sonar or an odometry unit, the navigation component generating a navigation signal using the input and the map; and a display device mounted to the shopping cart and coupled to the navigation component, the display device outputting path directions for the store based on the navigation signal.

Implementations may include any or all of the following features. The system further comprises a lidar mounted to the shopping cart and configured to provide at least part of the input to the navigation component. The system further comprises a camera mounted to the shopping cart and configured to provide at least part of the input to the navigation component. At least the odometry unit is mounted to the shopping cart and configured to provide the input to the navigation component, and wherein the odometry unit includes at least one odometry wheel mounted to the shopping cart. The wheels of the shopping cart include at least one non-swiveling wheel, and wherein the odometry wheel is mounted to the shopping cart at the non-swiveling wheel. At least the sonar is mounted to the shopping cart and configured to provide the input to the navigation component, the sonar oriented along a transverse direction that is perpendicular to a longitudinal axis of the shopping cart. The sonar includes first and second sonar units aimed opposite each other along the transverse direction. The display device comprises lights mounted in a circular pattern. At least some of the lights are configured to change color based on the navigation signal. The display device comprises a visual and tactile indicator.

In a second aspect, a computer-implemented method includes: receiving a list including item identifiers for items; associating the list with a shopping cart having wheels, the shopping cart associated with a store; associating the item identifiers with respective coordinates using a database associated with a store, the coordinates corresponding to locations of the items within the store; planning a path for the shopping cart using the coordinates and a map of the store; receiving input from at least one of a sonar or an odometry unit, the sonar or the odometry unit mounted to the shopping cart; determining a location of the shopping cart within the store using the input and the map; and outputting path directions using a display device mounted to the shopping cart, the path directions based on at least the planned path and the determined location.

Implementations may include any or all of the following features. The computer-implemented method further comprises receiving a user parameter and taking into account the user parameter in planning the path. The user parameter comprises at least one of fastest route, fixed-time route, or coordination with another list. The determination indicates that the shopping cart is at one of the locations of the items, and wherein outputting the path directions comprises pointing, using the display device, toward the item associated with the location. The list is submitted using a device, the method further comprising receiving a code scanned from the shopping cart using the device, wherein the code is used in associating the list with the shopping cart. The computer-implemented method further comprises providing the coordinates to a navigation component mounted to the shopping cart, the navigation component having at least one processor and a memory, the memory having access to the map of the store. The computer-implemented method further comprises receiving at least part of the input from at least one of a lidar or camera, the lidar or the camera mounted to the shopping cart. The database is connected to a store application programming interface (API), the method further comprising updating the database using information received using the store API. Outputting the path directions comprises generating haptic output to the shopping cart.

In a third aspect, a system includes: a navigation component configured to be mounted to a shopping cart having wheels, the navigation component having at least one processor and a memory, the navigation component having access to a map of a store; configured to be mounted to the shopping cart and provide input to the navigation component, at least one of a sonar or an odometry unit, the navigation component generating a navigation signal using the input and the map; and a display device configured to be mounted to the shopping cart and coupled to the navigation component, the display device outputting path directions for the store based on the navigation signal.

### BRIEF DESCRIPTION OF DRAWINGS

FIG. 1 shows an example of a system that provides path directions relating to a shopping cart.

FIGS. 2-3 show examples of the odometry unit of the shopping cart of FIG. 1.

FIGS. 4-5 show examples of the odometry unit of FIG. 1.

FIG. 6 shows an example of the lidar and sonar unit of the shopping cart of FIG. 1.

FIGS. 7-9 show examples of the lidar and sonar unit of FIG. 1.

FIGS. 10-11 show examples of the display device of FIG. 1.

FIG. 12 shows another example of the display device of FIG. 1.

FIGS. 13A-B show examples of sonar housing unis.

FIGS. 14A-B show examples of camera housing units.

FIG. 15 shows an example block diagram of a system that provides path directions relating to a shopping cart.

FIG. 16 shows a behavior tree for providing path directions relating to a shopping cart.

FIG. 17 shows an example block diagram of a navigation component.

FIG. 18 shows an example sequence diagram for a device, a bot, a database, and a cart system.

FIG. 19 shows an example of a map of a store.

FIG. 20 shows an example of a computer device that can be used to implement the techniques described here.

Like reference symbols in the various drawings indicate like elements.

### DETAILED DESCRIPTION

This document describes examples of systems and techniques that provide path directions relating to a shopping cart. The provided path directions can be tailored to a shopping list associated with a customer, so that the shopping cart guides the customer through the store in a particular manner based on the goods or other items on the shopping list. As another example, the path directions may be provided to a user other than a customer who is operating the shopping cart in the store. The path directions can be provided in real time based on an up-to-date detection of the shopping cart's location within the store.

Some examples in the present description refer to the person operating a shopping cart as a customer. The term customer is intended to cover each of several different scenarios, including, but not limited to: The customer is shopping for himself/herself, or for the customer's family; the customer is helping another customer who is also in the store with collecting some of the items for the other customer; the customer is shopping for a friend as a favor; the customer is shopping on behalf of an organization (e.g., a company where the customer works); the customer is shopping on behalf of a person who has entered into an agreement with the customer or with an organization associated with the customer; and/or combinations of the above scenarios.

As such, the customer who operates the shopping cart may be (but is not necessarily) any or all of the following: 1) the person to whom ownership of the goods will eventually be transferred; 2) the person who moves the items from a shelf or other storage location and places the items on the shopping cart; 3) the person who will bring the shopping cart through the checkout area; 4) the person who will administer payment to the store for the goods; 5) the person whose funds will be used for payment to the store; or 6) the person who will remove the purchased goods from the store. That is, some or all of the above functions may be performed other than by the person who is operating the shopping cart. For example, one or more of the above functions may be performed by another person, in a semi-automatic fashion, or in a fully automatic way.

The person to whom path directions for the shopping cart are generated may be a user other than a customer. In some implementations, an employee of the store may operate a shopping cart in relation to one or more items of the store. For example, items that are to be placed (or replaced) onto store shelves may be registered/identified (e.g., by way of a scanning operation) to generate a list of the items, and based on such a list the shopping cart may provide path directions to the employee to bring the shopping cart with the items to their designated location(s).

Some examples in the present description refer to the establishment where the goods or other items on the shopping list are located as a store. The term store is intended to cover each of multiple scenarios, including, but not limited to: A retail establishment (e.g., a grocery store, electronics store, clothing store, hardware store, and/or a pharmacy); a wholesale establishment (e.g., offering purchase in bulk or in larger quantities); an establishment having a human cashier (e.g., operating a scanner at a cash register); an establishment having a self-checkout station (e.g., based on a scanner); an establishment having automatic detection of the goods or items to be purchased (e.g., by capturing of visual or other signals); an establishment that is at least partially under roof; an establishment that is at least partially outdoors; and/or combinations thereof.

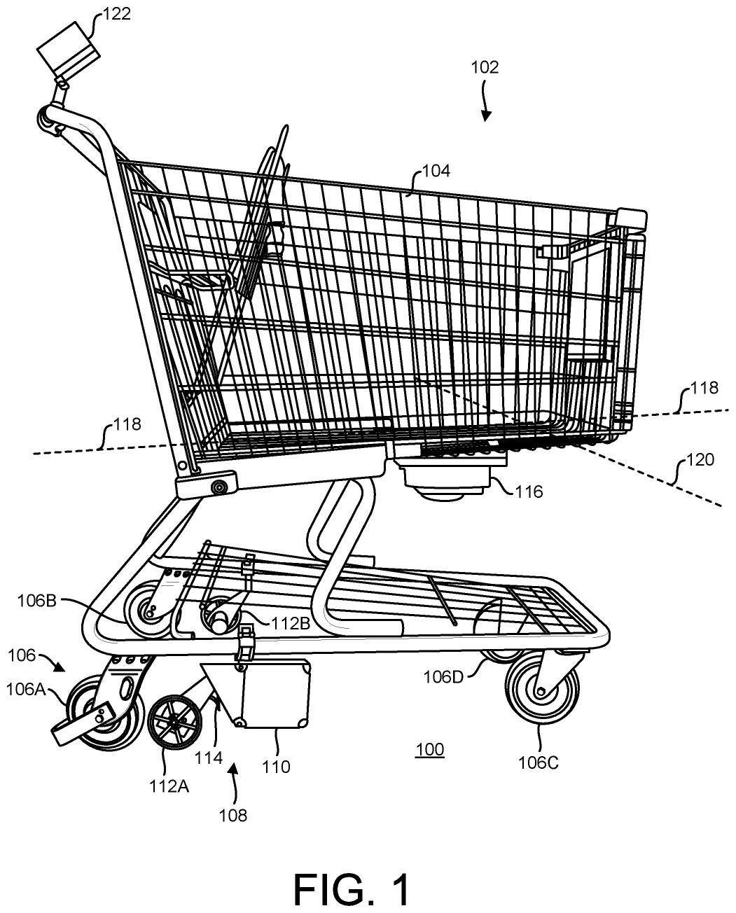

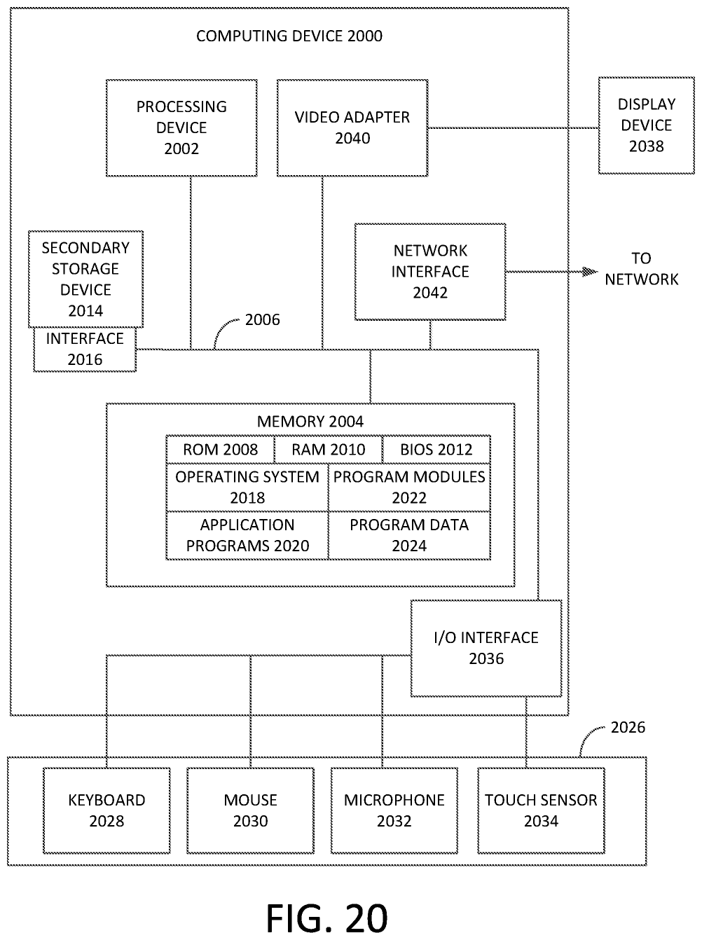

FIG. 1 shows an example of a system 100 that provides path directions relating to a shopping cart 102. The system 100 may be used with one or more other examples described elsewhere herein. Some aspects of the system 100 may be implemented using examples described with reference to FIG. 20.

The shopping cart 102 is designed to serve as a vehicle for transporting goods or other items. In some implementations, the shopping cart 102 may be used by a customer shopping in a retail store. For example, the shopping cart 102 may be used for shopping at a grocery store. The shopping cart 102 may include one or more containers or other receptacles for items. Here, the shopping cart 102 includes a container 104.

The shopping cart 102 may include wheels 106. In some implementations, one or more of the wheels 106 may be a swiveling wheel. In some implementations, one or more of the wheels 106 may be a non-swiveling wheel. For example, here wheels 106A-B are positioned toward a rear of the shopping cart 102 and are non-swiveling, and wheels 106C-D are placed toward a front of the shopping cart 102 and are swiveling.

The system 100 may include an odometry unit 108 mounted to the shopping cart 102. The odometry unit 108 may include an odometry component 110 coupled to one or more odometry wheels 112A-B. The odometry component 110 can include a processing component and/or other circuitry configured for registering movement of the shopping cart 102. In some implementations, the odometry component 110 may be implemented using examples described with reference to FIG. 20.

The odometry wheels 112A-B include one or more types of encoder (e.g., a rotary encoder) to generate a signal to the odometry component, the signal corresponding to rotation of the corresponding odometry wheel 112A-B. For example, the odometry wheel 112A-B touches the floor or ground and rotates as the shopping cart 102 is moved. As another example, the odometry wheel 112A-B touches a rotatable part of the shopping cart 102 (including, but not limited to, one or more of the wheels 106), and rotates as the shopping cart 102 is moved. The signal from the odometry wheels 112A-B may be provided to the odometry component 110 by a wired or a wireless connection. For example, here a cable 114 connects the odometry wheel 112A to the odometry component 110. With a wireless connection, the cable 114 may be omitted. The odometry unit 108 may measure movement using one or more of multiple different granularities. For example, each revolution of one or more of the odometry wheels 112A-B can be counted and converted into a distance measurement. As another example, a fraction of a revolution of one or more of the odometry wheels 112A-B can be counted and converted into a distance measurement. As another example, multiple revolutions of one or more of the odometry wheels 112A-B can be counted and converted into a distance measurement.

In some implementations, the system 100 includes a navigation component configured to receive input from the odometry component 110, the input generated based on the signal(s) from at least one or more of the odometry wheels 112A-B. Such a navigation component may determine a location of the shopping cart 102 based at least in part on the received input(s). In some implementations, the navigation component may be part of the odometry component 110, or vice versa. Examples of a navigation component are described below, including with reference to FIG. 17.

The system 100 may be powered in one or more ways. In some implementations, a power source is mounted to the shopping cart 102. Such a power source may power one or more components mounted to the shopping cart 102. In some implementations, a rechargeable power source, including, but not limited to, an electrochemical cell, may be mounted to the shopping cart 102. In some implementations, a generator may be mounted to the shopping cart 102. For example, the generator may generate energy based on the rotation of one or more of the wheels 106 during movement of the shopping cart 102. In some implementations, a photovoltaic system, including, but not limited to one or more solar panels, may be mounted to the shopping cart 102. For example, the photovoltaic system may recharge an onboard battery that serves as a power source.

The above examples and other examples described herein refer to something (here a “first thing”) being mounted to something else (here a “second thing”). The expression mounted to is intended to cover each of multiple situations, including, but not limited to: The first thing is mounted directly to (e.g., touches, abuts, or is otherwise in contact with) the second thing; the first thing is not mounted directly to the second thing, but is mounted directly to a third thing, wherein the third thing is mounted directly to the second thing; the first thing is mounted directly to the third thing, which is not mounted directly to the second thing but is mounted directly to a fourth thing, wherein the fourth thing is mounted directly to the second thing. As such, the expression mounted to includes both directly mounting to and indirectly mounting to, to name just two examples.

The system 100 may include at least one lidar component and/or at least one sonar component. Here, a lidar and sonar unit 116 is mounted to the shopping cart 102. A lidar may illuminate, using a light source, one or more objects in the area surrounding the shopping cart 102 and measure reflected light using a sensor. In some implementations, the lidar may generate pulsed laser light and may detect reflected pulses. The lidar may determine a distance to one or more objects or other structures based on the illumination and detection. The lidar may include any component that can determine a distance based on light illumination and detection.

A sonar may emit sound, using a sound generator (e.g., a speaker), and measure reflected sound (e.g., “echo”) from one or more objects in the area surrounding the shopping cart 102 using a sound detector (e.g., a microphone). In some implementations, the sonar may emit pulses of sound and may detect reflected pulses. The sonar may determine a distance to one or more objects or other structures based on the sound emission and detection. The sonar may include any component that can determine a distance based on sound emission and detection.

In some implementations, the lidar and sonar unit 116 includes at least one lidar and at least one sonar. The lidar may generate one or more signals to be used as input to the navigation component. For example, the navigation component may use the signal(s) from the lidar in determining a location of the shopping cart 102. The sonar may generate one or more signals to be used as input to the navigation component. For example, the navigation component may use the signal(s) from the sonar in determining a location of the shopping cart 102. In some implementations, the navigation component may be included in the lidar and sonar unit 116, or vice versa.

A longitudinal axis 118 of the shopping cart 102 is indicated. The longitudinal axis 118 may be considered a centerline that runs between the front and the rear of the shopping cart 102 and that divides the shopping cart 102 into a left side and a right side. For example, a customer operating the shopping cart 102 may walk essentially in the direction of the longitudinal axis 118. A transverse axis 120 of the shopping cart 102 is indicated. The transverse axis 120 may extend in a substantially horizontal plane and be perpendicular to the longitudinal axis 118. For example, the transverse axis 120 may indicate respective right and left directions from the perspective of the customer operating the shopping cart 102.

The sonar of the lidar and sonar unit 116 may be oriented in at least one direction substantially along the transverse axis 120. In some implementations, at least two sonar units are used, each configured to emit sound and detects the echo(es) thereof. For example, at least one of the sonar units may be oriented in one direction along the transverse axis 120 (e.g., to the left from the customer's perspective) and at least another one of the sonar units may be oriented in an opposite direction along the transverse axis 120 (e.g., to the right from the customer's perspective).

The lidar of the lidar and sonar unit 116 may be oriented in at least one direction relative to the shopping cart 102. In some implementations, the lidar generates illumination, and detects reflections, in a plane defined by the longitudinal axis 118 and the transverse axis 120. For example, the lidar may operate substantially in a 360-degree range around the shopping cart 102.

The system 100 includes one or more components for providing output to the customer(s). In some implementations, visual, audio, and/or haptic (e.g., tactile) output may be generated. For example, the system 100 here includes a display device 122 mounted to the shopping cart 102. The display device 122 may be coupled to the navigation component to output one or more path directions relating to the shopping cart 102. For example, the path direction(s) may inform the customer about the path toward one or more of the items of the store.

Any type of shopping cart may be used with the system 100. In some implementations, a container may include a mesh or other wire structure. For example, the container 104 may include a mesh structure. A mesh structure may include metal and/or plastic. In some implementations, the shopping cart 102 may not include any container. For example, the shopping cart 102 may include one or more platform on which the item(s) may be placed for transport. In some implementations, the shopping cart 102 may have more than one tier. For example, multiple containers can be positioned in tiers, such as one above another. In some implementations, the shopping cart 102 includes a shopping carriage and/or a flat-pack cart. For example, the shopping cart 102 may have multiple (e.g., four) wheels, a substantially upright handle for the customer to hold, and at least one substantially horizontal loading surface for the item(s) to be carried.

In some implementations, the shopping cart 102 is a pre-existing cart that has been provided with the other components of the system 100 in order to provide for navigation and provision of path directions. In other implementations, a new shopping cart may be provided with some or all of the other components of the system 100 before being used in a store. For example, a manufacturer of shopping carts may install components (e.g., some or all of the other components of the system 100) as part of one or more models of shopping carts being manufactured.

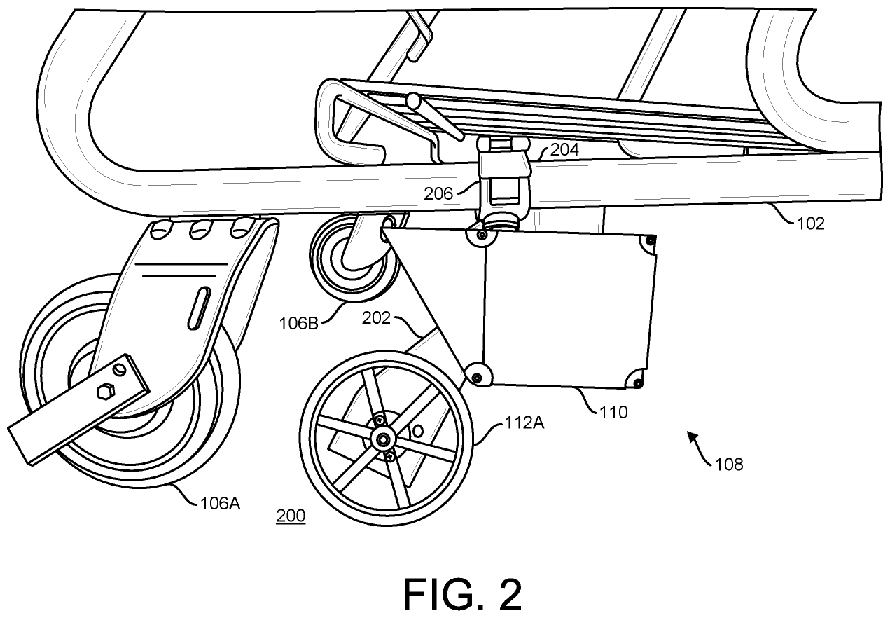

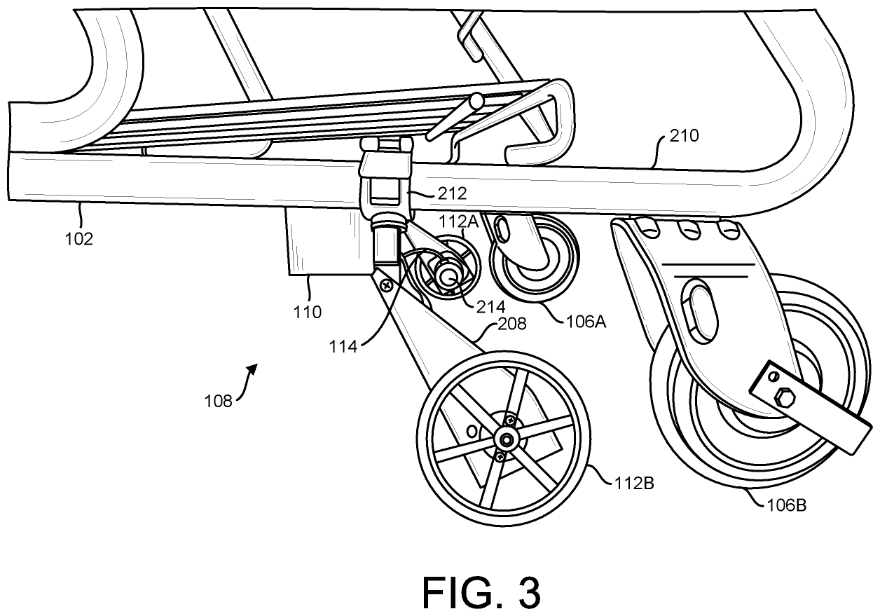

FIGS. 2-3 show examples of the odometry unit 108 of the shopping cart of FIG. 1. The odometry unit 108 may be used with one or more other examples described elsewhere herein. Here, the odometry wheel 112A is positioned against a surface 200 (e.g., a floor or the ground) so as to be rotated by the movement of the shopping cart 102. The odometry wheel 112A is rotatably coupled to a linkage 202. For example, the odometry wheel 112A may be rotatably mounted to an axis attached to the linkage 202. As another example, an axis attached to the odometry wheel 112A may be rotatably mounted to the linkage 202. The linkage 202 may be mounted to the shopping cart 102. In some implementations, the linkage 202 is mounted directly to a frame 204 of the shopping cart 102. In some implementations, the linkage 202 is mounted directly to the odometry component 110, which may be mounted to the frame 204. In some implementations, the mounting to the frame 204 may be accomplished using at least one clamp 206. The clamp 206 may fully or partially embrace the frame 204.

The linkage 202 may include at least one hinge. In some implementations, the hinge may allow the linkage 202 and the odometry wheel 112A to be properly positioned relative to the surface 200 for different distances between the frame 204 and the surface 200. For example, a biasing element (e.g., a spring) may urge the odometry wheel 112A toward the surface 200 so that proper contact between them is established.

In FIG. 3, the shopping cart 102 is seen from an opposite direction compared to FIG. 2. Here, the odometry wheel 112B is rotatably mounted to a linkage 208 which is directly mounted to a frame 210 of the shopping cart 102 by a clamp 212. Each of the odometry wheels 112A-B may have a rotary encoder. Here, a rotary encoder 214 is visible at the odometry wheel 112A. The rotary encoder 214 may be coupled to the odometry component 110 by the cable 114.

The odometry unit 108 may be mounted to the shopping cart 102 in any of multiple positions. In some implementations, the odometry unit 108 is mounted to the shopping cart 102 at (e.g., adjacent, near, or in the vicinity of) at least one of the wheels 106A-B. The wheels 106A-B may be non-swiveling wheels of the shopping cart 102, which may improve the performance of the odometry unit 108. For example, the odometry wheels 112A-B may be mounted to the shopping cart 102 closer to the wheels 106A-B than to other wheels of the shopping cart 102.

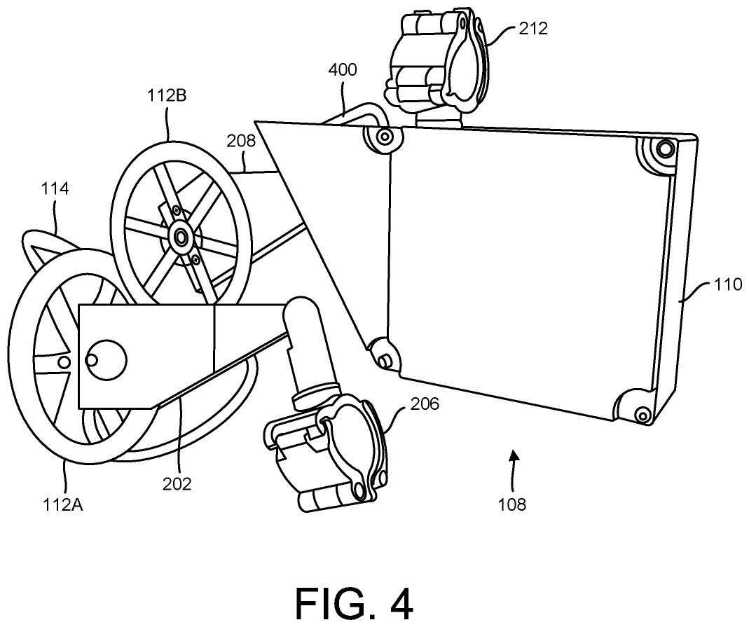

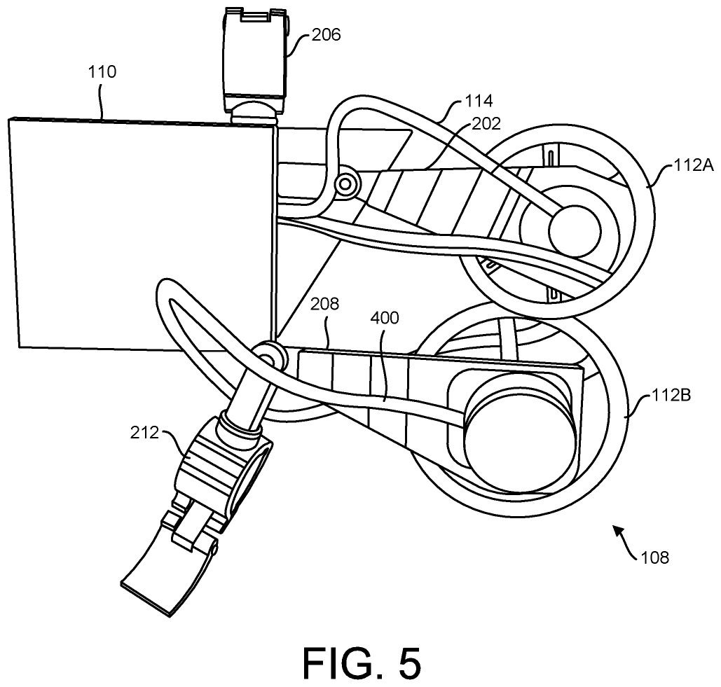

FIGS. 4-5 show examples of the odometry unit 108 of FIG. 1. In these examples, the odometry unit 108 is shown separate from other system parts or components. Here, the odometry wheel 112A and the linkage 202 are coupled to the clamp 206, and connected to the odometry component 110 by the cable 114. The odometry wheel 112B and the linkage 208 are coupled to the clamp 212, and connected to the odometry component 110 by a cable 400. With a wireless connection, the cable 400 may be omitted.

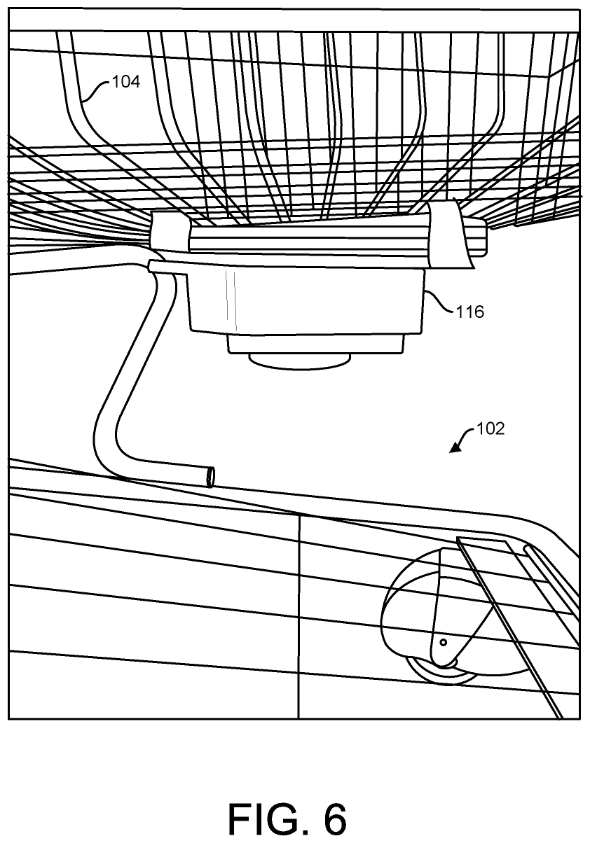

FIG. 6 shows an example of the lidar and sonar unit 116 of the shopping cart 102 of FIG. 1. The lidar and sonar unit 116 may be mounted to the shopping cart 102 in any of multiple locations. Here, the lidar and sonar unit 116 is mounted to an exterior bottom surface of the container 104.

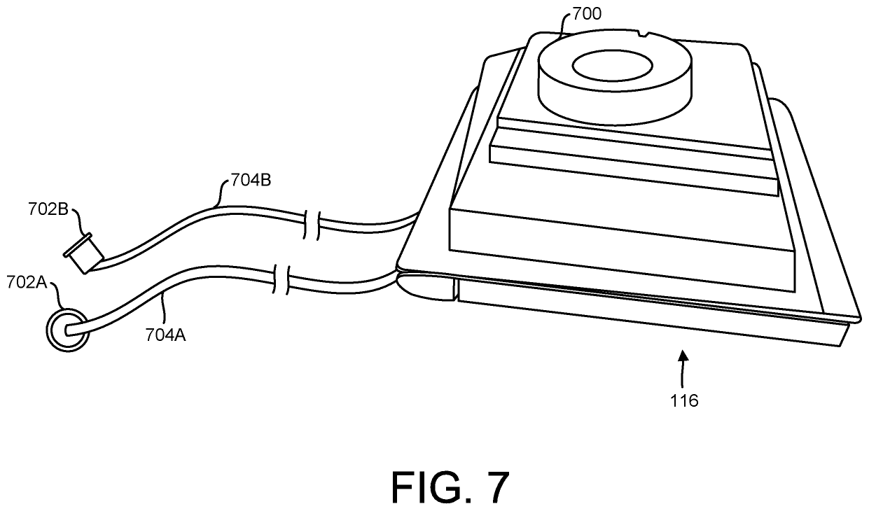

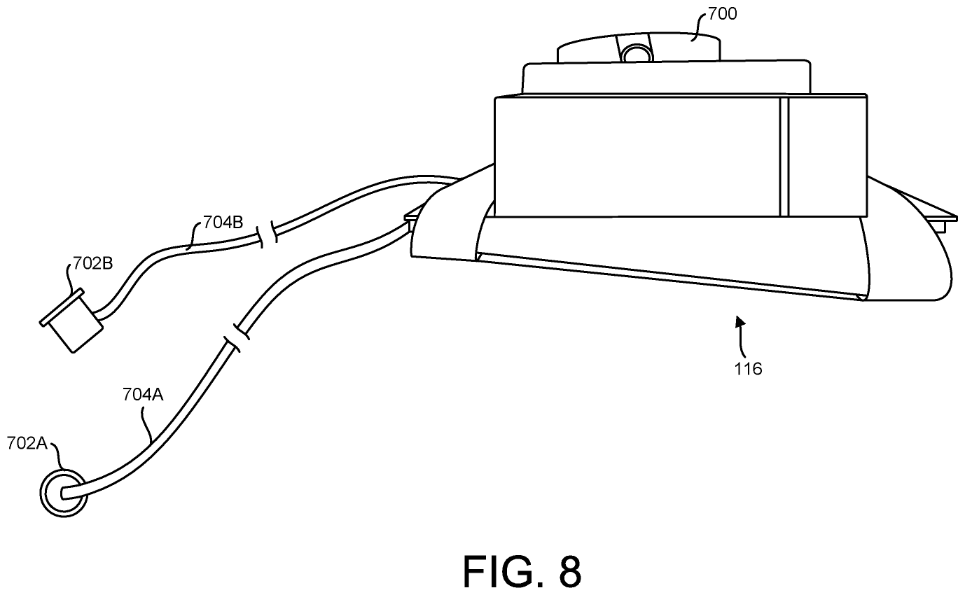

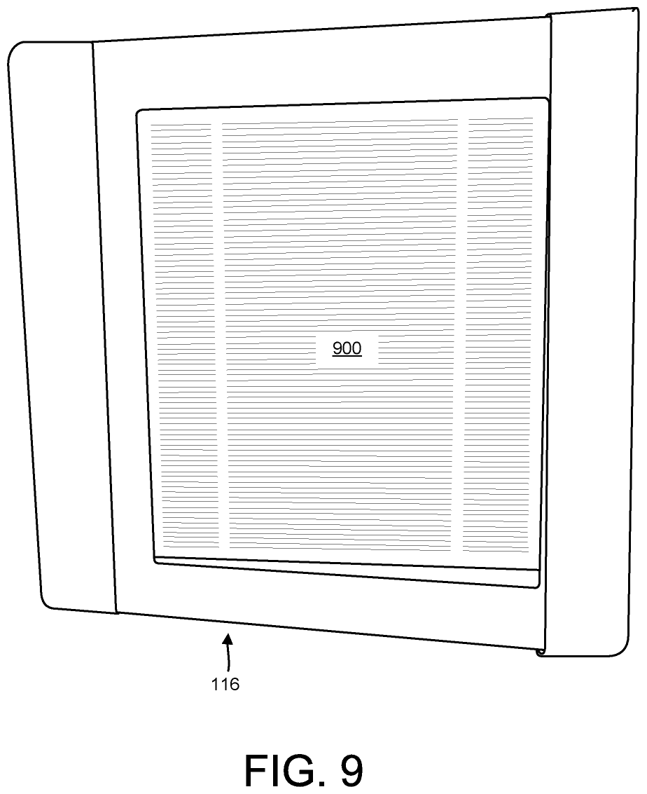

FIGS. 7-9 show examples of the lidar and sonar unit 116 of FIG. 1. In these examples, the lidar and sonar unit 116 is shown separate from other system parts or components. Here, the lidar includes a lidar component 700. In some implementations, the lidar component is configured to generate illumination (e.g., laser pulses) in multiple directions. For example, the lidar component 700 may contain a rotatable component that emits illuminating light in essentially a 360-degree range about the lidar and sonar unit 116.

The sonar of the lidar and sonar unit 116 may include sonar units 702A-B coupled to the lidar and sonar unit 116. The coupling may be wired or wireless. In some implementations, the sonar units 702A-B may be coupled by cables 704A-B, respectively. With a wireless connection, the cables 704A-B may be omitted. In some implementations, the sonar units 702A-B are configured for emitting sound and receiving reflected sound. For example, each of the sonar units 702A-B may include a sound transmitter and a sound receiver. The sonar units 702A-B may be oriented in the same direction as each other, or in different directions. For example, the sonar units 702A-B may be aimed opposite each other (e.g., along the transverse axis 120 in FIG. 1).

The lidar and sonar unit 116 may be powered by one or more types of energy source. In some implementations, the lidar and sonar unit 116 is directly or indirectly powered by a solar panel 900 (e.g., a photovoltaic component) that converts sunlight and/or artificial light into electricity. For example, the solar panel 900 may recharge an onboard battery which in turn may power components of a shopping cart. solar panel 900 may be positioned on at least one surface of the lidar and sonar unit 116.

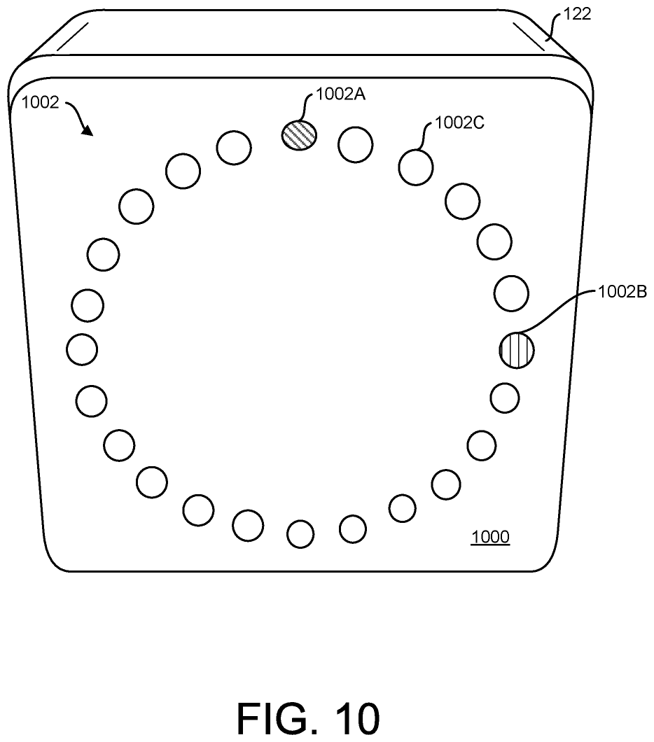

FIGS. 10-11 show examples of the display device 122 of FIG. 1. The display device can be coupled to a navigation component (e.g., a processor-based component and/or other circuitry) that provides a navigation signal that triggers the display device 122 to output one or more path directions to the customer. The display device 122 here includes a face 1000 that may be oriented toward the customer. The face 1000 may be formed on a housing of the display device 122. For example, the face 1000 may be aimed generally rearward in the shopping cart (e.g., along the longitudinal axis 118 in FIG. 1) and pitched to be visible to the customer (e.g., angled to face somewhat upward). The orientation of the display device 122 may be adjustable by the customer.

In some implementations, the display device 122 includes lights 1002 positioned on the face 1000 or visible through openings therein. The lights 1002 are individually addressable, controlled by circuitry of the display device 122, and may present path directions to the customer. The lights 1002 may be mounted in any pattern (e.g., having any density or sparsity of light elements) on the face 1000. Here, the lights are mounted substantially in a circular pattern on the face 1000. The lights 1002 may involve any suitable technology. In some implementations, the lights 1002 include light-emitting diode (LED) components.

The lights 1002 may direct the customer where to go. This may involve illuminating one or more of the lights 1002 to form a path direction to the customer. In some implementations, illumination of a light 1002A which is situated at a twelve o′clock position on the face 1000 may correspond to a path direction of moving straight forward. In some implementations, illumination of a light 1002B which is situated at a three o′clock position on the face 1000 may correspond to a path direction of turning to the right. Nuanced path directions may be output by also or instead illuminating others of the lights 1002. For example, illumination of a light 1002C, which is positioned in a clockwise location after the light 1002A on the way toward the light 1002B, may correspond to a path direction of bearing slightly to the right.

Some or all of the lights 1002 may have different colors. In some implementations, multicolor LEDs may be used. For example, this may allow illuminating one or more of the lights 1002 with any of multiple available colors to generate a specific path direction. In some implementations, illuminating one or more of the lights 1002 in a green color (e.g., as here schematically indicated for the light 1002A using diagonal stripes), may correspond to a path direction to proceed in the indicated direction (in this example, forward). In some implementations, illuminating one or more of the lights 1002 in a red color (e.g., as here schematically indicated for the light 1002B using vertical stripes), may correspond to a path direction to stop, and that the item(s) may be found in the indicated direction (in this example, to the right). That is, at least some of the lights 1002 may be configured to change color based on the navigation signal from the navigation component.

The display device 122 may be mounted to the shopping cart (e.g., the shopping cart 102 in FIG. 1) in any of multiple ways. In some implementations, a clamp 1004 is attached to the housing of the display device 122 and may be mounted to the shopping cart.

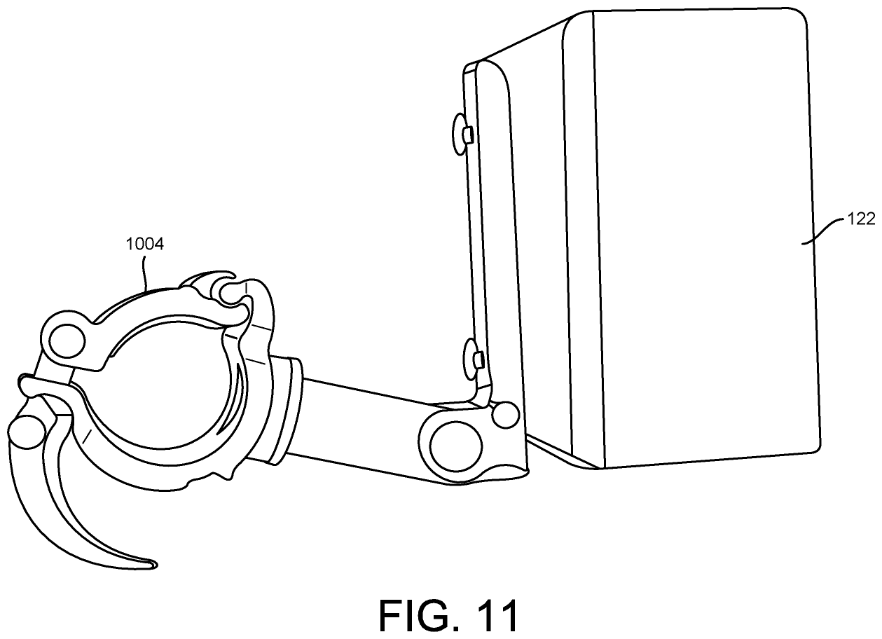

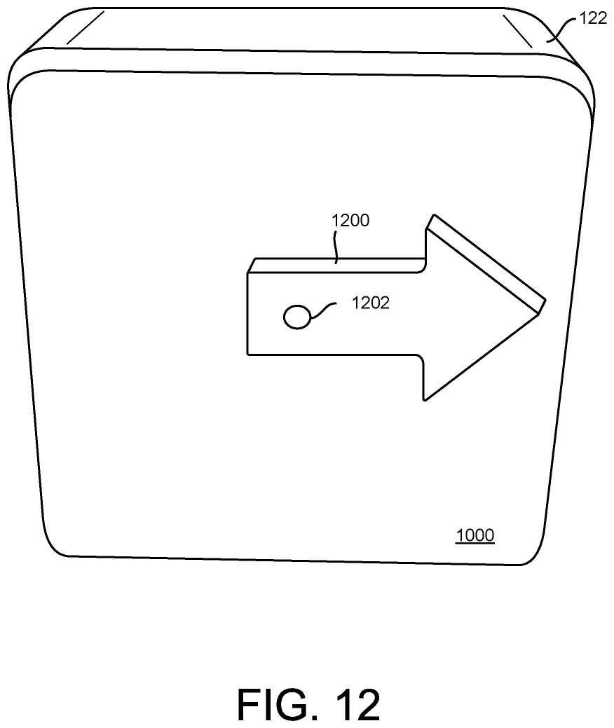

FIG. 12 shows another example of the display device 122 of FIG. 1. The display device 122 may include one or more visual and tactile indicator. Here, the display device 122 includes a rotatable arrow 1200 at the face 1000. The rotatable arrow 1200 may rotate (e.g., pivot in either direction) about an axis 1202, for example by being driven by a motor or other actuator inside the housing of the display device 122.

The rotatable arrow 1200 may be positioned to indicate one or more path directions. For example, the orientation of the rotatable arrow 1200 provides a visual indication of the direction. As another example, the user may touch the rotatable arrow 1200 with his or her hand to obtain a tactile indication of the direction. In some implementations, orienting the rotatable arrow 1200 toward the right (e.g., as shown) may correspond to a path direction to turn right. In some implementations, orienting the rotatable arrow 1200 in another direction (e.g., upward, to the left, or downward) may correspond to a path direction to proceed in the indicated direction (e.g., forward, to the left, or backward, respectively). Other visual and/or tactile indicators that allow the user to visually and/or tactilely perceive the path direction(s) may be used.

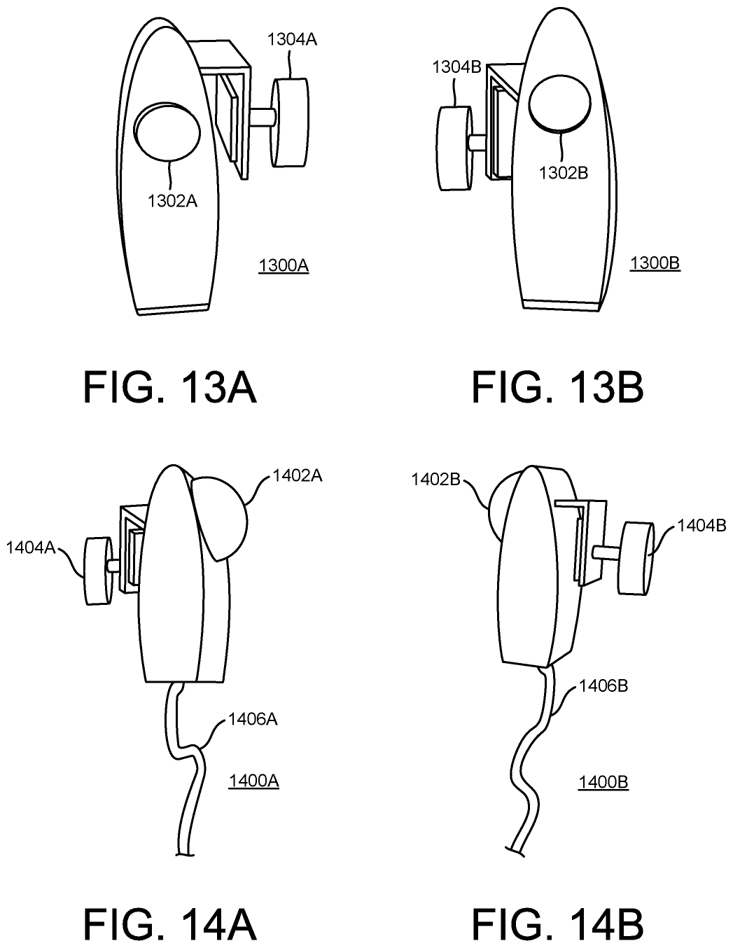

FIGS. 13A-B show examples of sonar housing units 1300A-B. The sonar housing units 1300A-B may be used with one or more other examples described elsewhere herein. The sonar housing units 1300A-B may be made of one or more suitable materials. For example, the sonar housing units 1300A-B may be cast and/or machined from metal, or formed by molding a plastic material. The sonar housing unit 1300A includes a cavity 1302A and the sonar housing unit 1300B includes a cavity 1302B. In some implementations, the sonar unit 702A (FIG. 7) may be positioned in the cavity 1302A, and the sonar unit 702B may be positioned in the cavity 1302B. The sonar housing units 1300A-B can be mounted to the shopping cart using clamps 1304A-B, respectively. In some implementations, the sonar housing units 1300A-B facilitate placing the sonar units 702A-B in substantially opposite directions to each other. For example, the sonar housing units 1300A-B may be positioned at the exterior bottom surface of the container 104 (FIG. 1), toward the front of the shopping cart 102.

FIGS. 14A-B show examples of camera housing units 1400A-B. The camera housing units 1400A-B may be used with one or more other examples described elsewhere herein. The camera housing units 1400A-B may be made of one or more suitable materials. For example, the camera housing units 1400A-B may be cast and/or machined from metal, or formed by molding a plastic material. The camera housing unit 1400A includes a camera 1402A and the camera housing unit 1400B includes a camera 1402B. Any suitable type of camera may be used for the cameras 1402A-B, including, but not limited to, a digital camera of the kind(s) used in smartphones and/or as vehicle back-up cameras. For example, cameras used in some robotics applications (e.g., for navigation based on SLAM algorithms) may be used. The camera housing units 1400A-B can be mounted to the shopping cart using clamps 1404A-B, respectively. In some implementations, the camera housing units 1400A-B facilitate placing the cameras 1402A-B with any of various orientations relative to each other. Camera output (e.g., encoded image data) may be provided to one or more other system components by way of a wired or wireless connection, here by respective cables 1406A-B. For example, the cables 1406A-B may provide image data as input to a navigation component for use in determining a current location of the shopping cart. With a wireless connection, the cables 1406A-B may be omitted.

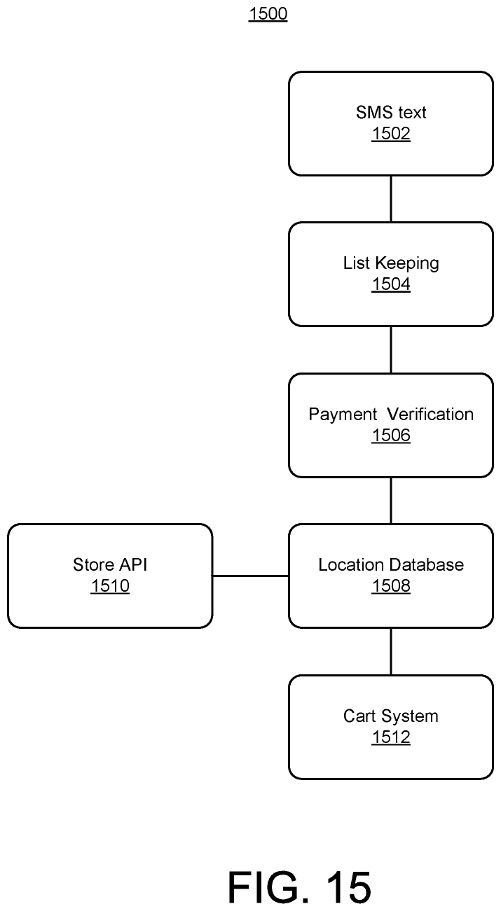

FIG. 15 shows an example block diagram of a system 1500 that provides path directions relating to a shopping cart. The system 1500 may be used with one or more other examples described elsewhere herein. Some aspects of the system 1500 may be implemented using examples described with reference to FIG. 20. For example, the components schematically illustrated as boxes may be implemented using a combination of hardware and software (e.g., firmware). Processing can be performed on a standalone unit or be distributed over two or more processing units, to name just a few examples.

The system 1500 includes an SMS (short message service) text component 1502 that provides a user interface. In some implementations, a user connects to the system 1500 by way of a text message (e.g., sent by the user using a smartphone). For example, sending a text message to a dedicated number will trigger the system 1500 to guide the user through the process. In some implementations, the system 1500 may provide a user interface for the user to create a shopping list of items. For example, the system 1500 may cause the user's smartphone (or other electronic device) to present one or more screens for identifying the items. Such screen(s) may include controls for free text entry, searching, selection from a predefined list, voice recognition capability, and combinations thereof, to name just a few examples. That is, the SMS text component 1502 may facilitate the user's identifying one or more items (e.g., goods from a store) to be added to a shopping list. In case where an item is not identified with enough specificity, the SMS text component 1502 may prompt the user for more information to avoid ambiguities and to ensure that the relevant item(s) can be identified with certainty. As another example, the SMS text component 1502 may inform the user that an identified item is not in stock at a particular store (e.g., because the store does not carry the item or because the store is currently out of stock).

The system 1500 includes a list keeping component 1504 configured for storing a shopping list generated using the SMS text component 1502. The shopping list may be stored in any suitable format, including, but not limited to, natural-language text, tagged text, encoded text, and/or product identifier. A product identifier may include one or more codes capable of uniquely identifying a product, including, but not limited to, codes such as Universal Product Code (UPC), European Article Number (EAN), International Standard Book Number (ISBN), and/or Manufacturer Part Number (MPN), to name just a few examples. That is, the list keeping component 1504 may facilitate that a shopping list of one or more goods or other items is created and stored as associated with a particular user.

The system 1500 includes a payment verification component 1506 that may prompt the user for payment regarding services relating to the shopping list and the provision of path directions during the shopping session. In some implementations, the payment verification component 1506 may provide a payment interface that is made accessible to the user (e.g., by sending the user a hyperlink to a payment screen). Payment may be received in any suitable way, including, but not limited to, by credit/debit card, electronic funds transfer, gift card, stored credit, bonus points, and combinations thereof, to name just a few examples. The payment verification component 1506 verifies that sufficient payment is received for the services related to the given user and may issue payment verification within the system 1500.

The system 1500 includes a location database 1508 that includes a map of at least one store and information about the locations of respective items in the store(s). The map may be generated based on a geospatial scanning of the store premises. For example, laser scanning (e.g., by a lidar) or acoustic scanning (e.g., by a sonar) may be performed to generate a digital map that depicts the aisles, passageways, and other areas of a store that customers have access to. As another example, the map may instead or also be generated based on photographs or blueprints regarding the building(s) where the store is located. That is, the map should include digital information that accurately defines the various areas of a store so as to serve as a basis for defining the locations of individual items. For example, the map may be based on coordinates in a plane or volume (e.g., (x,y)-coordinates, or (x,y,z)-coordinates) by which any given point in the store can be uniquely identified.

Information about item location may be stored in any suitable way. In some implementations, the information may be based on tuples that include the unique identifier for an item (e.g., its name and/or a code such as UPC, EAN, ISBN, and/or MPN) and information specifying the location. For example, the location for the identified item may be specified using (x,y)-coordinates.

The location database 1508 may receive the shopping list stored by the list keeping component 1504 and determine, for the item(s) of the list, the specific location(s) of the item(s) in the store. In some implementations, this involves generating an unsorted list of items on a shopping list, the items associated with respective coordinates that relate to the available map of the store.

The system 1500 includes a store application programming interface (API) 1510 that facilitates exchange of information between the system 1500 and a computer system associated with one or more stores. In some implementations, the system may receive one or more of the map or the item location information by way of the store API 1510. For example, the store API 1510 may be used for real time updates as to the locations of specific items in the store, and/or for information about item availability, store congestion, or store opening hours. As another example, the system 1500 may use the store API 1510 to provide information to the store reported by a user of the system 1500.

The system 1500 includes a cart system 1512 that may be installed onboard an individual shopping cart. In some implementations, the cart system 1512 is part of the system 100 in FIG. 1, or vice versa. The cart system 1512 may be configured to plan a path through the store for the particular shopping list stored by the list keeping component 1504. For example, an optimization algorithm may be executed based on the map of the store and the applicable location coordinates of the items on the shopping list. That is, the cart system 1512 may generate a set of path directions corresponding to a proposed route for the shopping cart to take through the store, the path directions covering all locations of the items relevant to the shopping list.

In some implementations, the cart system 1512 has the map stored therein. In some implementations, the map is stored at a system other than the cart system 1512. For example, a remote computer system may host the map and make it accessible to the cart system 1512, including, but not limited to, such that the cart system 1512 may navigate on the remotely hosted map. Any suitable communication protocol may be used for accessing a remotely hosted map, including, but not limited to, by packet-based messages (e.g., by internet protocol (IP) communication) between the remote system and the cart system 1512. For example, one or more sensors on the shopping cart (e.g., an odometry unit, a lidar, a sonar, and/or a camera) may be configured for directly or indirectly engaging in IP communication.

The cart system 1512 may provide one or more types of information to another component of the system 1500. In some implementations, information from one or more sensors onboard a shopping cart may be provided to the store's computer system by way of the store API 1510. The store's computer system may integrate such information into its inventory management practices. For example, the store may use images from a camera on the shopping cart in managing the inventory of the store.

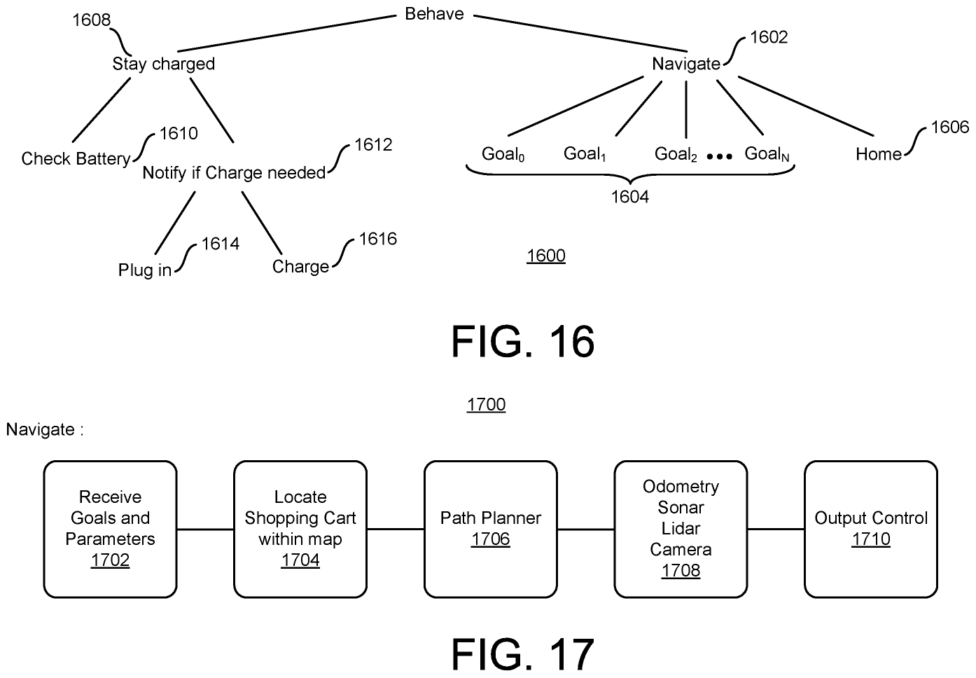

FIG. 16 shows a behavior tree 1600 for providing path directions relating to a shopping cart. The behavior tree 1600 may be used with one or more other examples described elsewhere herein. Some aspects of the behavior tree 1600 may be implemented using examples described with reference to FIG. 20.

The behavior tree 1600 may be applied by any system, or by a part of a system, that is involved in providing path directions relating to a shopping cart. In some implementations, the behavior tree 1600 relates to a navigation component in the system 100 of FIG. 1. As another example, the cart system 1512 in FIG. 15 may be configured to exhibit some or all behaviors of the behavior tree 1600.

The behavior tree 1600 includes a navigate behavior 1602 that involves navigating to one or more locations relevant to a particular shopping list. In some implementations, N number of goals 1604 may be defined under the navigate behavior 1602:

Goal₀, Goal₁, Goal₂, . . . , Goal_{N},

where N=0, 1, 2, . . . . Each of the goals 1604 may correspond to the location within a store (e.g., the (x,y)-coordinates) of an item on the shopping list. In some implementations, the behavior that meets any of the goals 1604 may involve navigating from a current location to the location specified for the product at issue. For example, such navigation may be accomplished by present one or more path directions to the user.

The behavior tree 1600 includes a home behavior 1606 under the navigate behavior 1602. In some implementations, the home behavior 1606 corresponds to a default location that may be relevant each time the shopping cart is used. For example, the home behavior 1606 may correspond to the location of a cash register or other exit point from the store.

In some implementations, the navigate behavior 1602 may involve performing navigation to reach all of the goals 1604 and thereafter navigating to the default location as indicated by the home behavior 1606.

When the shopping cart is not involved in the navigate behavior 1602, it may remain idle or may be used for another purpose. In some implementations, the behavior tree 1600 includes a stay charged behavior 1608 relating to a rechargeable power supply (e.g., a battery) of the shopping cart. For example, a check battery behavior 1610 may relate to the shopping cart self-determining its state of charge to determine whether charging is needed. For example, the stay charged behavior 1608 may include a notify if charge needed behavior 1612 that relates to generating one or more types of alert relating to charging of the battery. For example, the alert can direct a person to connect the rechargeable power supply to a power source. A plug in behavior 1614 relates to connecting the rechargeable power supply to the power source. A charge behavior 1616 relates to the process of replenishing the rechargeable power supply.

FIG. 17 shows an example block diagram of a navigation component 1700. The navigation component 1700 may be used with one or more other examples described elsewhere herein. Some aspects of the navigation component 1700 may be implemented using examples described with reference to FIG. 20. The navigation component 1700 may be implemented onboard a shopping cart, including, but not limited to, on the shopping cart 102 of FIG. 1 and/or in the cart system 1512 of FIG. 15.

The navigation component 1700 includes a component 1702 to receive at least one goal and at least one parameter. The goal may be one of the goals 1604 of FIG. 16. For example, the goal may correspond to the (x,y)-parameter of a specific product on the shopping list. The parameter(s) may relate to the performance of navigation. In some implementations, the parameter specifies some aspect(s) relating to the planning of a path for the shopping cart, including, but not limited to, a fastest route, fixed-time route, or coordination with another shopping list, and combinations thereof. For example, specifying the parameter as fastest route may cause the navigation component 1700 to select the one route, among multiple possible routes covering the same items on the shopping list, which will require the shortest time to traverse. For example, specifying the parameter as fixed-time route may cause the navigation component 1700 to select a route that is estimated to take a predefined time to traverse. For example, specifying the parameter as coordination with another shopping list may cause the navigation component 1700 to coordinate the path of the shopping list with the path for another shopping list pertaining to the same store.

The navigation component 1700 includes a component 1704 to locate the shopping cart in relation to the map of the store. The component 1704 may include a navigation component, and the map may be held by the navigation component, or the navigation component may access the map on a remote resource. The map may be accessible to at least both the location database 1508 of FIG. 15 and the cart system 1512. For example, the component 1704 may receive input from one or more devices on the shopping cart and determine the location based on the input(s).

The navigation component 1700 includes a path planner component 1706 to plan a path based on locations (e.g., coordinates) relating to the items of a shopping list. The path planning may involve correlating the locations with the map of the store, and finding path segments to connect pairs of the locations to each other so that a continuous path is defined through the store. Such path planning may be done based on tools (e.g., optimization algorithms) available for motion planning (e.g., in the field of robotics). For example, a strategic localization and mapping (SLAM) algorithm may be implemented by the path planner component 1706.

The navigation component 1700 includes a component 1708 that controls and/or receives input from one or more of an odometry unit (e.g., the odometry unit 108 of FOG. 1), a sonar (e.g., the sonar units 702A-B of FIG. 7 and/or the lidar and sonar unit 116 of FIG. 1), a lidar (e.g., the lidar and sonar unit 116 of FIG. 1), or a camera (e.g., a digital camera configured for imaging the surroundings of the shopping cart). In some implementations, the input(s) made available by the component 1708 may be provided to the component 1704 for use in determining the present location of the shopping cart at the store (i.e., to identify the location on the map of the store).

The component 1708 may facilitate that input from two or more of the odometry unit, sonar, lidar, or camera is taken into account. In some implementations, lidar may not work satisfactorily in an aisle bounded by glass panels (e.g., the freezer section of a grocery store). For example, odometry and/or sonar may be used in such situations.

The navigation component 1700 includes an output control component 1710 that provides one or more path directions to the user. Such path directions may correspond to the path planned by the path planner component 1706 (e.g., as determined by a SLAM algorithm). In some implementations, the output control component 1710 is configured for generating visual output. For example, the output control component 1710 may illuminate one or more of the lights 1002 (FIG. 10) to guide the customer to move or stop the shopping cart. In some implementations, the output control component 1710 is configured for generating audio output. For example, the output control component 1710 can verbally give the user a path direction (e.g., by speaking the phrase “move forward” or “stop here”). In some implementations, the output control component 1710 is configured for generating tactile output. For example, an actuator in contact with the handle of the shopping cart (e.g., with the frame of the shopping cart) can generate haptic output that the customer recognizes as a path direction (e.g., to move or stop the shopping cart).

Examples described herein illustrate a system (e.g., the system 100 of FIG. 1) that comprises a shopping cart (e.g., the shopping cart 102 of FIG. 1) having wheels (e.g., the wheels 106A-D of FIG. 1); a navigation component (e.g., the navigation component 1700 of FIG. 17) mounted to the shopping cart, the navigation component having at least one processor (e.g., the processing device 2002 of FIG. 20) and a memory (e.g., the memory 2004 of FIG. 20), the memory having stored therein a map of a store; mounted to the shopping cart and configured to provide input to the navigation component, at least one of a sonar (e.g., the sonar units 702A-B of FIG. 7 and/or the lidar and sonar unit 116 of FIG. 1) or an odometry unit (e.g., the odometry unit 108 of FIG. 1), the navigation component generating a navigation signal (e.g., by way of the component 1708 of FIG. 17) using the input and the map; and a display device (e.g., the display device 122 of FIG. 1) mounted to the shopping cart and coupled to the navigation component, the display device outputting path directions (e.g., using the lights 1002 of FIG. 1 and/or the rotatable arrow 1200 of FIG. 12) for the store based on the navigation signal.

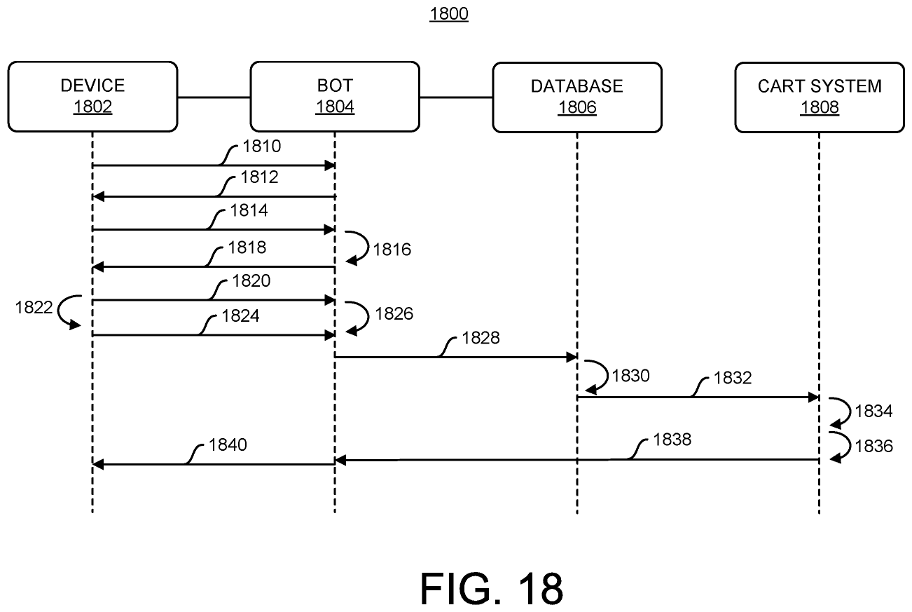

FIG. 18 shows an example sequence diagram 1800 for a device 1802, a bot 1804, a database 1806, and a cart system 1808. The sequence diagram 1800 may be used with one or more other examples described elsewhere herein. Some aspects of the components of the sequence diagram 1800 may be implemented using examples described with reference to FIG. 20. For example, the database 1806 may include the location database 1508 of FIG. 15, or vice versa. As another example, the cart system 1808 may include the navigation component of the system 100 of FIG. 1 and/or the cart system 1512 of FIG. 15. More or fewer operations than show may be performed. Two or more operations may be performed in a different order unless otherwise indicated.

The device 1802 may generate a communication 1810 (e.g., a message by wireless or wired network) to the bot 1804. In some implementations, the communication 1810 serves as a way for the user of the device 1802 to initiate the process of generating a shopping list and thereafter facilitate the receipt of path directions relating to that shopping list while collecting the items at a store. For example, the communication 1810 may include a text message.

The bot 1804 may generate a communication 1812 to the device 1802 in response to the communication 1810. In some implementations, the communication 1812 provides a user interface for the user to identify one or more items to be placed on the shopping list. For example, the communication 1812 may inform the user how to identify the item(s) and may facilitate correct formatting of that information.

The device 1802 may generate a communication 1814 to the bot 1804 in response to the communication 1812. In some implementations, the communication 1814 contains information identifying one or more items to be placed on the shopping list.

The bot 1804 may perform an operation 1816 of verifying that a valid shopping list has been received. Such a verification may trigger one or more other operations. In some implementations, the bot 1804 may generate a communication 1818 to the device 1802 requesting payment from the user. For example, the communication 1818 may include instructions for completing an online payment (e.g., by a third-party payment service).

The device 1802 may generate a communication 1820 to the bot 1804 in response to the communication 1818. The communication may include confirmation details indicating that a payment has been authorized or completed. In some implementations, the communication 1820 may be sent to the bot 1804 by the third-party payment service. The communication 1820 (optionally in combination with other information) allows the bot 1804 to verify that payment has been received.

The operations exemplified above may be performed in a preparation phase, including, but not limited to, when the user is planning to visit a store to purchase some items.

In order for the user to receive path directions corresponding to the user's shopping list while operating a particular shopping cart, the user may identify the shopping cart to the system involved in the sequence diagram 1800. In some implementations, the user selects one of multiple available shopping carts at the store where the user intends to go shopping, and enters an identifier for that shopping cart into the device 1802. For example, an operation 1822 may involve the device 1802 capturing (e.g., using a built-in camera) the identifier of the shopping cart (e.g., a QR code, barcode, name, or other unique identification). The device 1802 may generate a communication 1824 to the bot 1804 in response to the operation 1822. For example, the communication 1824 may convey the identifier of the selected shopping cart to the bot 1804.

The bot 1804 may perform an operation 1826 of verifying that payment has been received. In some implementations, the user may select the shopping cart and identify it to the bot 1804 before providing the payment.

The bot 1804 may generate a communication 1828 to the database 1806. In some implementations, the communication 1828 includes the shopping list generated by the user. The database may be dedicated to a single store, or the communication 1828 may identify the particular store to the database 1806 (e.g., the identity of the shopping cart may imply one of multiple candidate stores). The database 1806 may store the generated shopping list. The database 1806 may perform an operation 1830 of determining locations for the items on the shopping list relative to the map of the store. For example, this may generate an unsorted list of coordinates for the user's items.

The database 1806 may generate a communication 1832 to the cart system 1808. The communication 1832 may include information about the determined locations of the shopping-cart items (e.g., an unsorted list of coordinates). The database 1806 may send the communication 1832 to the particular shopping cart selected by the user (e.g., based on an identifier that the device 1802 shares at the communication 1824).

The cart system 1808 may include a navigation component that processes the received information. For example, at an operation 1834 the cart system may plan a path for the locations of the items on the user's shopping cart.

At 1836, the cart system 1808 may perform one or more operations relating to location determination and provision of path direction. The cart system 1808 uses input from one or more of an odometry unit, a sonar, a lidar, or a camera, to determine the location of the shopping cart with which the cart system 1808 is associated. In some implementations, the input can be processed and the result(s) compared with a map of the store, to determine the (most likely) location of the shopping cart. For example, the cart system 1808 may narrow down the universe of all possible cart locations on the map of the store to only the single location that is consistent with the input(s) being processed.

Based on determining the location, the cart system 1808 may provide one or more path directions to the user. For example, visual, audio, and/or tactile output may be generated. The operation(s) may be performed for each item on the shopping list, to facilitate transport of the shopping cart along the planned path. The operation 1836 may end upon the cart system 1808 determining that the shopping is finished (e.g., after the user reaches a cash register or other exit point).

The cart system 1808 may generate a communication 1838 to the bot 1804 that indicates the end of the shopping session. For example, the communication 1838 may trigger the bot 1804 to register the shopping list submitted by the user as finished. The bot 1804 may generate a communication 1840 to the device 1802 in response to the communication 1838. In some implementations, the communication 1840 may indicate to the user that the shopping session has terminated. For example, this can signify that no more charges relating to use of the shopping cart will be attributed to the user.

The sequence diagram 1800 illustrates an example of a computer-implemented method that comprises: receiving a shopping list (e.g., in communication 1814) including item identifiers for items; associating the shopping list with a shopping cart having wheels (e.g., after receiving the communication 1824), the shopping cart associated with a store; associating (e.g., in operation 1830) the item identifiers with respective coordinates using a database associated with a store, the coordinates corresponding to locations of the items within the store; planning (e.g., in operation 1834) a path for the shopping cart using the coordinates and a map of the store; receiving input (e.g., in operation 1836) from at least one of a sonar or an odometry unit, the sonar or the odometry unit mounted to the shopping cart; determining (e.g., in operation 1836) a location of the shopping cart within the store using the input and the map; and outputting path directions (e.g., in operation 1836) using a display device mounted to the shopping cart, the path directions based on at least the planned path and the determined location.

One or more types of information may be provided to the device 1802 in relation to the sequence diagram 1800. In some implementations, content may be presented on the device 1802 (e.g., visually and/or audibly) during and/or after the time that the user provides a shopping list. For example, the bot 1804 may provide one or more custom advertisements to the device 1802 based on the user's shopping list.

A shopping cart may share (e.g., using the cart system 1512 in FIG. 15) one or more types of data with another system. In some implementations, the shopping cart may share its location (e.g., in form of one or more location coordinates and/or a signal that reflects the location). For example, a third-party system receiving the data may use it to provide location-based services and/or serve advertisements.

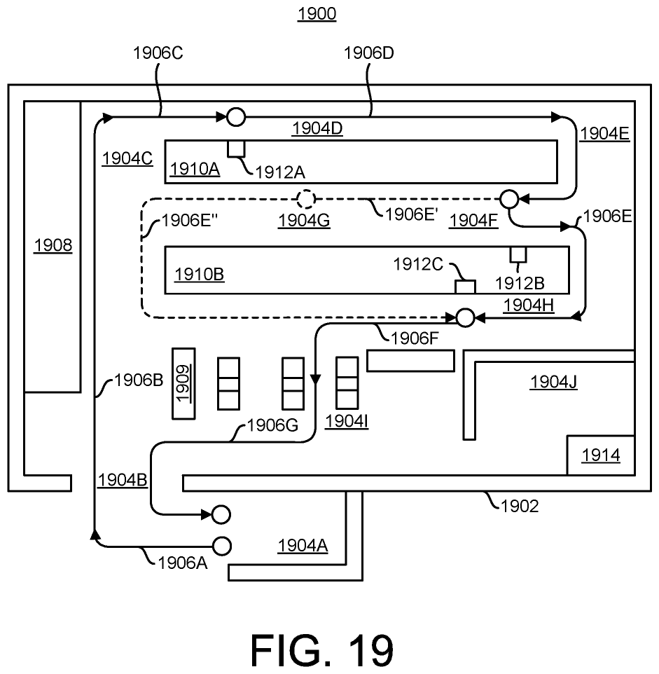

FIG. 19 shows an example of a map 1900 of a store. The map 1900 may be used with one or more other examples described elsewhere herein. Some aspects of the generation or use of the map 1900 may be implemented using examples described with reference to FIG. 20.

The map 1900 schematically shows a top view of a building 1902 having, among other features and characteristics, respective areas 1904A-J. In some implementations, the building 1902 corresponds to a retail establishment. For example, the building 1902 may be a grocery store.

The area 1904A may include a corral for shopping carts. In some implementations, the area 1904a may be an outdoor location intended to be visited immediately prior to (or after) visiting the store. For example, a customer may pick up or drop off a shopping cart at the area 1904A. In some implementations, the customer picks up the shopping cart after having submitted a shopping list in electronic form, provided payment for path direction services, and identified the selected shopping cart to the system. Here, a path segment 1906A corresponds to the customer approaching an area 1904B which has an opening into the building 1902 (e.g., a main entry/exit of the store) with the selected shopping cart.

The shopping cart has a cart system onboard that includes the map 1900 and one or more devices (e.g., one or more of an odometry unit, a sonar, a lidar, or a camera) to facilitate location determination. A navigation component may initially calibrate itself by determining its correct location relative to the map 1900 so as to be able to correlate further movement with new positions on the map 1900. In some implementations, the navigation component recognizes (e.g., using sonar, lidar, and/or camera) that it passes through the opening at the area 1904B and may therefore identify its present location on the map 1900.

Based on the determined location, the shopping cart may generate a path direction telling the customer to proceed straight forward. The customer here does so, and the shopping cart traverses a path segment 1906B inside the building 1902. In doing so, the sonar, lidar, and/or camera may register that the shopping cart passes by shelves 1908, 1909 and 1910A-B inside the store. As another example, the odometry unit may register that the shopping cart traverses the distance of the path segment 1906B. For example, respective odometry wheels on the sides of the shopping cart may generate essentially identical outputs, which indicates that the shopping cart is not being turned in either direction (in which situation the odometry wheels would generate different outputs).

At the area 1904C, the shopping cart may generate a path direction that the customer should turn the shopping cart to the right and then proceed straight ahead. In doing so, the customer traverses a path segment 1906C with the shopping cart. Upon reaching the area 1904D, the shopping cart may generate a path direction to stop, and that the location is to the customer's right. Here, the shelf 1910A includes an item 1912A which is on the shopping list. Accordingly, the path directions have guided the customer to the area 1904A to pick up the item 1912A. For example, this may involve a determination by a navigation component that the shopping cart is at one of the locations of the items, and the path directions may include pointing, using a display device, toward the item associated with the location.

After a predetermined time, or upon determining that the customer is finished at the area 1904D, the shopping cart may generate a path direction to proceed along a path segment 1906D. Upon reaching the area 1904E, the path direction may instruct the customer to turn the shopping cart around the end of the shelf 1910A and enter the aisle between the shelves 1910A-B. Upon reaching the area 1904F, the shopping cart may generate a path direction to stop, and that the location is to the customer's left. Here, the shelf 1910B includes an item 1912B which is on the shopping list. Accordingly, the path directions have guided the customer to the area 1904F to pick up the item 1912B.

Subsequently, the shopping cart may generate a path instruction to proceed along path segment 1906E which leads to the area 1904H. Upon reaching the area 1904H, the shopping cart may generate a path direction to stop, and that the location is to the customer's right. Here, the shelf 1910B includes an item 1912C which is on the shopping list. Accordingly, the path directions have guided the customer to the area 1904G to pick up the item 1912C.

Subsequently, the shopping cart may generate a path instruction to proceed along path segment 1906F which leads to the area 19041 (e.g., a cash register or other checkout area). Upon reaching the area 19041, the shopping cart may generate a path direction to stop and engage in a checkout procedure (e.g., scanning of the items and furnishing of payment therefor).

Subsequently, the shopping cart may generate a path direction to return to the area 1904A, corresponding to a path segment 1906G. For example, the customer or a store associate may return the shopping cart to the location where it may be picked up by another customer.

The shopping cart here traverses the path that includes the path segments 1906A-G which was the planned path for this shopping session. The planning of the path may depend on one or more parameters provided by or on behalf of the customer. In some implementations, the path that includes the path segments 1906A-G may correspond to the fastest route through the store given the items 1912A-C that were on the shopping list. In some implementations, the path that includes the path segments 1906A-G may be a route that takes a predetermined time to traverse. For example, this option may be selected in order to avoid complicated turns with the shopping cart, while ensuring that the shopping does not take an overly long time.

In some implementations, a user parameter may correspond to an instruction to coordinate the path being planned with at least one other path. In some implementations, this can be done to allow multiple shopping lists to be handled simultaneously. For example, two friends may want to talk through the store together while they get the items on their respective shopping lists. As another example, a customer may wish to collect items for two shopping lists at the same time (e.g., when the customer is shopping on behalf of two persons). An example will now be described.

In this example, the path for a first shopping list is being coordinated with the path for a second shopping list. Assume, for example, that the first and second shopping lists relate to respective areas of the building 1902 as follows:

| First shopping list | Second shopping list | Coordinated shopping list |
|---|---|---|
| Area 1904A | Area 1904A | Area 1904A |
| Area 1904B | Area 1904B | Area 1904B |
| Area 1904C | Area 1904G | Area 1904C |
| Area 1904D | Area 1904H | Area 1904D |
| Area 1904E | Area 1904I | Area 1904E |
| Area 1904F | | Area 1904F |
| Area 1904H | | Area 1904G |
| Area 1904I | | Area 1904H |
| | | Area 1904I |

That is, the first shopping list in part relates to the areas 1904C-F which are not relevant to the second shopping list, and the second shopping list in part relates to the area 1904G which is not relevant to the first shopping list. The coordinated shopping list, as indicated, involves all of the areas 1904A-I. That is, taking into account the coordinated shopping list in the path planning may allow the first and second shopping lists to be taken care of while traversing the path of the coordinated shopping list.

In terms of path directions regarding the coordinated shopping list, at the area 1904F the customer(s) may be instructed to proceed forward, further along the aisle between the shelves 1910A-B, according to a path segment 1906E′, and stop at the area 1904G. After retrieving the item at the area 1904G (which relates to the second shopping list), the customer(s) may be instructed to proceed to the area 1904H along a path segment 1906E″. As such, the path that includes the path segments 1906A-D, 1906E′-E″, and 1906F-G is one example of coordinating two or more shopping lists.

The area 1904J of the store may be an office equipped, among other things, with a store computer system 1914 which may be implemented using examples described with reference to FIG. 20. The store computer system 1914 may keep track of items stored in the building 1902, and control the cash registers or other equipment at the area 19041, to name just two examples. In some implementations, the store API 1510 of FIG. 15 may allow communication with the store computer system 1914. For example, the store computer system 1914 may inform the system 1500 of FIG. 15 about items that are in stock (or not), or about new locations on the map 1900 for one or more items.

A technical problem addressed by examples of the present disclosure may include how to effectively and reliably plan the route through a store for one or more shopping session. Another technical problem may be how to effectively and reliably guide a customer through the store according to the planned path. The present disclosure addresses the first technical problem above by providing for mapping of a store, entry of items on the shopping list, and identification of the particular shopping cart that is to be used. The present disclosure addresses the second technical problem above by providing at least one device for outputting path directions in real time to the user.

Advantages of implementations of the present subject matter may include, but are not limited to: Providing an improved store procedure for a user (e.g., allowing a customer to shop while engaging in conversation with a companion or over the phone); providing improved premises management for a store owner; assisting a visually challenged user at a store; assisting a memory-challenged user at a store; and/or facilitating more effective shopping according to one or more shopping lists.

FIG. 20 illustrates an example architecture of a computing device 2000 that can be used to implement aspects of the present disclosure, including any of the systems, apparatuses, and/or techniques described herein, or any other systems, apparatuses, and/or techniques that may be utilized in the various possible embodiments.

The computing device illustrated in FIG. 20 can be used to execute the operating system, application programs, and/or software modules (including the software engines) described herein.

The computing device 2000 includes, in some embodiments, at least one processing device 2002 (e.g., a processor), such as a central processing unit (CPU). A variety of processing devices are available from a variety of manufacturers, for example, Intel or Advanced Micro Devices. In this example, the computing device 2000 also includes a system memory 2004, and a system bus 2006 that couples various system components including the system memory 2004 to the processing device 2002. The system bus 2006 is one of any number of types of bus structures that can be used, including, but not limited to, a memory bus, or memory controller; a peripheral bus; and a local bus using any of a variety of bus architectures.

Examples of computing devices that can be implemented using the computing device 2000 include a desktop computer, a laptop computer, a tablet computer, a mobile computing device (such as a smart phone, a touchpad mobile digital device, or other mobile devices), or other devices configured to process digital instructions.

The system memory 2004 includes read only memory 2008 and random access memory 2010. A basic input/output system 2012 containing the basic routines that act to transfer information within computing device 2000, such as during start up, can be stored in the read only memory 2008.

The computing device 2000 also includes a secondary storage device 2014 in some embodiments, such as a hard disk drive, for storing digital data. The secondary storage device 2014 is connected to the system bus 2006 by a secondary storage interface 2016. The secondary storage device 2014 and its associated computer readable media provide nonvolatile and non-transitory storage of computer readable instructions (including application programs and program modules), data structures, and other data for the computing device 2000.

Although the exemplary environment described herein employs a hard disk drive as a secondary storage device, other types of computer readable storage media are used in other embodiments. Examples of these other types of computer readable storage media include magnetic cassettes, flash memory cards, digital video disks, Bernoulli cartridges, compact disc read only memories, digital versatile disk read only memories, random access memories, or read only memories. Some embodiments include non-transitory media. Additionally, such computer readable storage media can include local storage or cloud-based storage.

A number of program modules can be stored in secondary storage device 2014 and/or system memory 2004, including an operating system 2018, one or more application programs 2020, other program modules 2022 (such as the software engines described herein), and program data 2024. The computing device 2000 can utilize any suitable operating system, such as Microsoft Windows™, Google Chrome™ OS, Apple OS, Unix, or Linux and variants and any other operating system suitable for a computing device. Other examples can include Microsoft, Google, or Apple operating systems, or any other suitable operating system used in tablet computing devices.

In some embodiments, a user provides inputs to the computing device 2000 through one or more input devices 2026. Examples of input devices 2026 include a keyboard 2028, mouse 2030, microphone 2032, and touch sensor 2034 (such as a touchpad or touch sensitive display). Other embodiments include other input devices 2026. The input devices can be connected to the processing device 2002 through an input/output interface 2036 that is coupled to the system bus 2006. These input devices 2026 can be connected by any number of input/output interfaces, such as a parallel port, serial port, game port, or a universal serial bus. Wireless communication between input devices 2026 and the input/output interface 2036 is possible as well, and includes infrared, BLUETOOTH® wireless technology, 802.11a/b/g/n, cellular, ultra-wideband (UWB), ZigBee, or other radio frequency communication systems in some possible embodiments, to name just a few examples.

In this example embodiment, a display device 2038, such as a monitor, liquid crystal display device, projector, or touch sensitive display device, is also connected to the system bus 2006 via an interface, such as a video adapter 2040. In addition to the display device 2038, the computing device 2000 can include various other peripheral devices (not shown), such as speakers or a printer.

The computing device 2000 can be connected to one or more networks through a network interface 2042. The network interface 2042 can provide for wired and/or wireless communication. In some implementations, the network interface 2042 can include one or more antennas for transmitting and/or receiving wireless signals. When used in a local area networking environment or a wide area networking environment (such as the Internet), the network interface 2042 can include an Ethernet interface. Other possible embodiments use other communication devices. For example, some embodiments of the computing device 2000 include a modem for communicating across the network.

The computing device 2000 can include at least some form of computer readable media. Computer readable media includes any available media that can be accessed by the computing device 2000. By way of example, computer readable media include computer readable storage media and computer readable communication media.

Computer readable storage media includes volatile and nonvolatile, removable and non-removable media implemented in any device configured to store information such as computer readable instructions, data structures, program modules or other data. Computer readable storage media includes, but is not limited to, random access memory, read only memory, electrically erasable programmable read only memory, flash memory or other memory technology, compact disc read only memory, digital versatile disks or other optical storage, magnetic cassettes, magnetic tape, magnetic disk storage or other magnetic storage devices, or any other medium that can be used to store the desired information and that can be accessed by the computing device 2000.

Computer readable communication media typically embodies computer readable instructions, data structures, program modules or other data in a modulated data signal such as a carrier wave or other transport mechanism and includes any information delivery media. The term “modulated data signal” refers to a signal that has one or more of its characteristics set or changed in such a manner as to encode information in the signal. By way of example, computer readable communication media includes wired media such as a wired network or direct-wired connection, and wireless media such as acoustic, radio frequency, infrared, and other wireless media. Combinations of any of the above are also included within the scope of computer readable media.

The computing device illustrated in FIG. 20 is also an example of programmable electronics, which may include one or more such computing devices, and when multiple computing devices are included, such computing devices can be coupled together with a suitable data communication network so as to collectively perform the various functions, methods, or operations disclosed herein.

A number of embodiments have been described. Nevertheless, it will be understood that various modifications may be made without departing from the spirit and scope of the invention.

In addition, the logic flows depicted in the figures do not require the particular order shown, or sequential order, to achieve desirable results. In addition, other steps may be provided, or steps may be eliminated, from the described flows, and other components may be added to, or removed from, the described systems.

What is claimed is:

1. A system comprising:
a shopping cart having wheels;
a navigation component mounted to the shopping cart, the navigation component having at least one processor and a memory, the navigation component having access to a map of a store;
mounted to the shopping cart and configured to provide input to the navigation component, at least one of a sonar or an odometry unit, the navigation component generating a navigation signal using the input and the map; and
a display device mounted to the shopping cart and coupled to the navigation component, the display device outputting path directions for the store based on the navigation signal.

2. The system of claim 1, further comprising a lidar mounted to the shopping cart and configured to provide at least part of the input to the navigation component.

3. The system of claim 1, further comprising a camera mounted to the shopping cart and configured to provide at least part of the input to the navigation component.

4. The system of claim 1, wherein at least the odometry unit is mounted to the shopping cart and configured to provide the input to the navigation component, and wherein the odometry unit includes at least one odometry wheel mounted to the shopping cart.

5. The system of claim 4, wherein the wheels of the shopping cart include at least one non-swiveling wheel, and wherein the odometry wheel is mounted to the shopping cart at the non-swiveling wheel.

6. The system of claim 1, wherein at least the sonar is mounted to the shopping cart and configured to provide the input to the navigation component, the sonar oriented along a transverse direction that is perpendicular to a longitudinal axis of the shopping cart.

7. The system of claim 6, wherein the sonar includes first and second sonar units aimed opposite each other along the transverse direction.

8. The system of claim 1, wherein the display device comprises lights mounted in a circular pattern.

9. The system of claim 8, wherein at least some of the lights are configured to change color based on the navigation signal.

10. The system of claim 1, wherein the display device comprises a visual and tactile indicator.

11. A computer-implemented method comprising:
receiving a list including item identifiers for items;
associating the list with a shopping cart having wheels, the shopping cart associated with a store;
associating the item identifiers with respective coordinates using a database associated with a store, the coordinates corresponding to locations of the items within the store;
planning a path for the shopping cart using the coordinates and a map of the store;
receiving input from at least one of a sonar or an odometry unit, the sonar or the odometry unit mounted to the shopping cart;
determining a location of the shopping cart within the store using the input and the map; and
outputting path directions using a display device mounted to the shopping cart, the path directions based on at least the planned path and the determined location.

12. The computer-implemented method of claim 11, further comprising receiving a user parameter and taking into account the user parameter in planning the path.

13. The computer-implemented method of claim 12, wherein the user parameter comprises at least one of fastest route, fixed-time route, or coordination with another list.

14. The computer-implemented method of claim 11, wherein the determination indicates that the shopping cart is at one of the locations of the items, and wherein outputting the path directions comprises pointing, using the display device, toward the item associated with the location.

15. The computer-implemented method of claim 11, wherein the list is submitted using a device, the method further comprising receiving a code scanned from the shopping cart using the device, wherein the code is used in associating the list with the shopping cart.

16. The computer-implemented method of claim 11, further comprising providing the coordinates to a navigation component mounted to the shopping cart, the navigation component having at least one processor and a memory, the memory having access to the map of the store.

17. The computer-implemented method of claim 11, further comprising receiving at least part of the input from at least one of a lidar or camera, the lidar or the camera mounted to the shopping cart.

18. The computer-implemented method of claim 11, wherein the database is connected to a store application programming interface (API), the method further comprising updating the database using information received using the store API.

19. The computer-implemented method of claim 11, wherein outputting the path directions comprises generating haptic output to the shopping cart.

20. A system comprising:
a navigation component configured to be mounted to a shopping cart having wheels, the navigation component having at least one processor and a memory, the navigation component having access to a map of a store;
configured to be mounted to the shopping cart and provide input to the navigation component, at least one of a sonar or an odometry unit, the navigation component generating a navigation signal using the input and the map; and
a display device configured to be mounted to the shopping cart and coupled to the navigation component, the display device outputting path directions for the store based on the navigation signal.
